(19) United States
(12) Patent Application Publication
(10) Pub. No.: US 2020/0200144 A1
(43) Pub. Date: Jun. 25, 2020

(54) Multistory power generation system

(71) Applicant: Rahul Thumbar, Rajkot, Gujrat-Strate (IN)

(72) Inventor: Rahul Thumbar, Rajkot (IN)

(21) Appl. No.: 16/620,754

(22) PCT Filed: Jun. 7, 2017
(86) PCT No.: PCT/IN2018/050372

§ 371 Date: Dec. 9, 2019

(30) Foreign Application Priority Data
Jun. 7, 2017 (IN) 201721019915

(51) Int. Cl. F03D 3/00; F03D 3/02; F03D 9/25; F03B 7/00; H02K 7/116; H02K 7/18

(52) U.S. Cl. CPC F03D 3/005; F03D 3/02; H02K 7/183; F03B 7/00; H02K 7/116; F03D 9/25

(57) ABSTRACT

Systems and methods for power generation comprising a tier and line up arrangement installing of the pioneer device, as such side by side line up merged multistory wind mill row of tower. Thus, the height and length of the multistory row windmill tower may be desirable or depend on capacity of project, while width of rotor of each floor may be stand between 10 to 40 feet are suitable or depend on capacity of project, and height of each floor/rotor 10 to 40 feet are suitable or depend on capacity of project. When the forward or backward wind blows the opened rotor of the each floor, the rotors turn in to circular motion, thus energy of the wind transfer in to drive generator via main shaft, to generate grid quality electricity.

### CROSS-REFERENCE TO RELATED APPLICATIONS

This application is a national stage application of PCT Application No. PCT/IN2018/050372. This application claims priority from PCT Application No. PCT/IN2018/050371, filed Jun. 7, 2017, Indian Application No. 201721019915 filed Jun. 7, 2017, the contents of which are incorporated herein in the entirety by reference.

Some references, which may include patents, patent applications, and various publications, are cited and discussed in the description of the present disclosure. The citation and/or discussion of such references is provided merely to clarify the description of the present disclosure and is not an admission that any such reference is “prior art” to the present disclosure described herein. All references cited and discussed in this specification are incorporated herein by reference in their entireties and to the same extent as if each reference was individually incorporated by reference.

### FIELD OF THE INVENTION

The present invention related to systems and methods of power generation, and in particular relates to systems and methods for power generation from wind, sea waves and water currents.

### BACKGROUND OF THE INVENTION

The sun heats our atmosphere unevenly, so some patches become warmer than other, these warm patches of air rise, other cold air replace them and we feel a wind current. The wind power is a one of the good source of clean and renewable energy, we can say, it's easily available on earth, worldwide free from nature, thus this wind power conversion electricity is very cheap, easy and low cost in install and to generate than any other electric project like thermal, gas, nuclear and hydro.

Wind energy is alternate renewable source that is becoming more notable. In present days horizontal turbine with three blades and generator mounted on tower. However those wind energy conversion system is not attractive. That they are low efficiency, high capital costs, and high maintenance costs. Energy is raising problem of developing world, so there is requirement to develop a simple, easier and economical system which can produce good electricity with minimum maintenance.

For the reason state above which will became contrived to those skilled in the art upon reading and understanding the present specification, there is need art for systems and methods for power generation of the ‘Wind power conversion device’.

In the existing methods and systems, there is a wind driven power producing systems which have been subject to prior patent applicationNumber1775/MUM/2009, filed on dated Mar. 8, 2009, by inventor Parsotam Panchabhai Thumbar, changed name of the title:—the ‘Wind power conversion device’ has a rotor mounted on the tower with shaft, said rotor having plurality of evenly planer blades which are arranged equally fixed angle on the shaft. Device further divided into two departments from assumed center line of horizontal rotor shaft. Among, one department surround by walls of tower to restrict direct wind current entry, where second half part will remain uncover, thus wind blow the uncovered rotor and the rotor shaft which drives a generator via different mechanical arrangements like; gears, pulleys, sprocket wheels, chains, freewheels and fly wheels, to generate electricity.

All this above involves device not possible build and install as giant size and does not usable for sea waves, water current and domestic power production.

### OBJECT OF THE INVENTION

The primary an object of this invention to provide novel methods and systems for the “Systems and methods for power generation of the ‘Wind power conversion device”, which can be using wind, sea waves and water current at high efficiency and produce high yield of electricity.

### BRIEF SUMMARY OF THE INVENTION

There are systems and methods to efficiently extract good yield of electricity from “Wind power conversion device”.

In an embodiment, the multistory power generation system consists of plurality of horizontal axis wind power conversion devices arranged in multi stage/storey wind mill tower. The rotors connected to drive generator via rotor shafts, fly wheeled gears with main shaft, opposite free wheel gears, and generator gear.

In one embodiment, two multistory wind mill tower installed and merger side by side.

In one embodiment, multi stage/storey wind mill tower installs in plurality side by side in a row.

In another embodiment, an multistory power generation system consists of plurality of vertical axis wind power conversion device installing mirror image as twin tower and mirror image as tier installing become vertical twin multistory tower. The common rotor shaft connected the generator via gear box. The generator may be installed on top or bottom of the building.

In one embodiment, vertical twin multi storey tower installed in plurality side by side, in one row, become vertical multi storey row tower system, while vertical multi story tower installed as one side row except last tower, become vertical one sided row multistory tower system.

In an embodiment, a multistory power generation system consist of vertical axis wind power conversion device includes revolving wind protect curtain which rotate automatic or motorized to hide half of the rotor blade against wind flow.

In an embodiment, rotor shaft connected the generator via gearbox, and a tower according to desired height.

In an embodiment, wind, water currents and sea wave power generation systems. The wind, water currents and sea wave power generation systems have arrangement of wind power conversion device like, single multistory tier arrangement tower building of power generation, twin multistory tier arrangement tower building of power generation and row of tier arrangement tower building of power generation, vertical arrangement of wind power conversion device like, mirror imaged vertical installed twin tower of power generation, mirror imaged vertical installed tier arrangement multistory twin tower, mirror imaged vertical installed tier arrangement multistory twin tower row of power generation, vertical one side installed tier arrangement multistory row tower of power generation, automation with vertical arrangement of wind power conversion device like, vertical installed wind directional operated automatic curtain adjustment round singled tower of power generation, vertical installed motorized operated automatic curtain adjustment round singled tower of power generation, vertical tier installed motorized operated automatic curtain adjustment round singled multistory tower of power generation.

### BRIEF DESCRIPTION OF THE DRAWINGS

FIG. 1a is prospective pioneer view of wind power conversion device;

FIG. 1b is simplified vertical installation of FIG. 1a;

FIG. 1c is upper view of rotor cover like half cutting of barrel, according to embodiment as disclosed herein;

FIG. 1d shows vertical position welded component parted rotor, according to embodiment as disclosed herein;

FIG. 1e shows cross sectional view of FIG. 1 (without slope) with the modified half round rotor cover, according to embodiment as disclosed herein;

FIG. 2 illustrates tier arrangement of the devices of the FIG. 1b as a tower or multistory windmill tower, with a vertical fitted shaft, gears and generator, for generating electricity, in accordance with an exemplary embodiment;

FIG. 3 shows cross sectional view of tier arranged devices of the FIG. 1a as if the cement concrete column-beam as multistory wind mill tower; according to embodiment as disclosed herein;

FIG. 4a illustrates an upper floor of the multistory wind mill tower, front and back sides of upper floor are large in size than other lower floor, according to embodiment as disclosed herein;

FIG. 4b illustrates an upper floor of the multistory wind mill tower, and left and right sides of the upper floor are large in size than other lower floor, according to embodiment as disclosed herein;

FIG. 4c illustrates an upper floor of the multistory wind mill tower, when left, right, front and back sides are large in size of upper floor than other lower floors, according to embodiment as disclosed herein;

FIG. 5 illustrates front view of tier arrangement of wind mill devices if the FIG. 1a as multistory twin tower with vertical main shaft, gears and generator; otherwise twin tower arrangement of the FIG. 2, for generating electricity in accordance with an exemplary embodiment.

FIG. 6a illustrates front view of tier arrangement of wind mill devices of the FIG. 1a as multistory tower row with a vertical fitted shaft, gears and single generator, for generating electricity or of the FIG. 2 as a row, according to embodiment as disclosed herein;

FIG. 6b illustrates front view of tier arrangement of wind mill devices of the FIG. 1a as multistory row of tower of the FIG. 2 as long row with individual generator per floor, in accordance with an exemplary embodiment,

FIG. 7a illustrates front view of vertical axis device of the FIG. 1b as mirror image installing twin wind mill tower with individual generator on top of the towers, according to embodiment as disclosed herein;

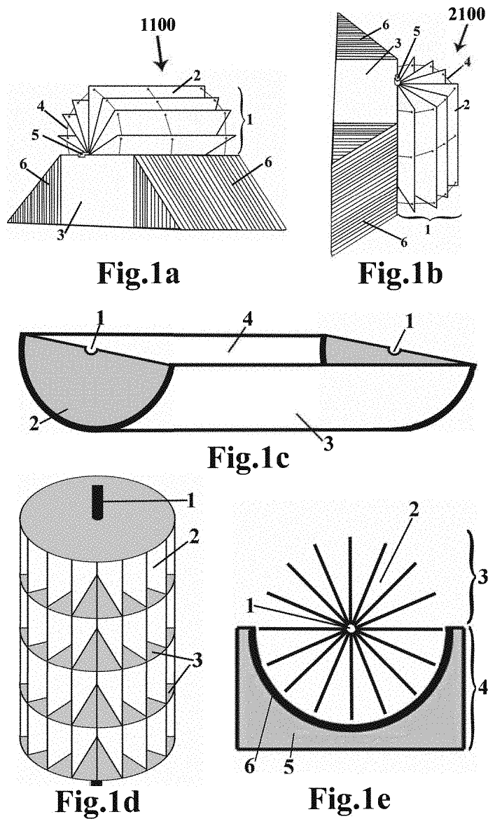

FIG. 1b illustrates front view of vertical axis device of the FIG. 1b as mirror image installing twin tower with horizontal shafted common generator on top of the tower, generating electricity from wind, sea waves and water current, in accordance with an exemplary embodiment,

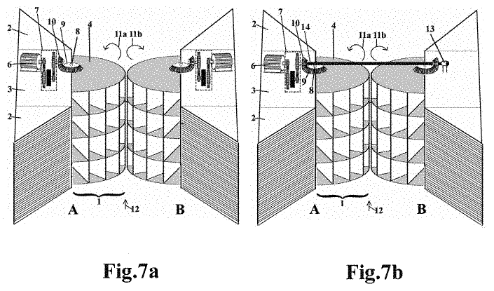

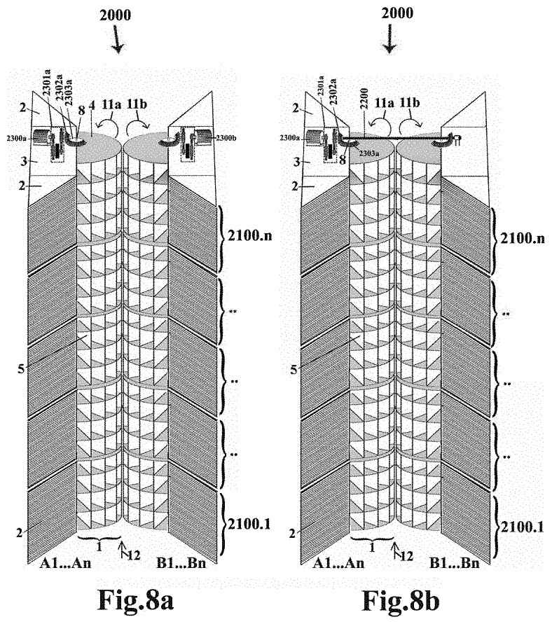

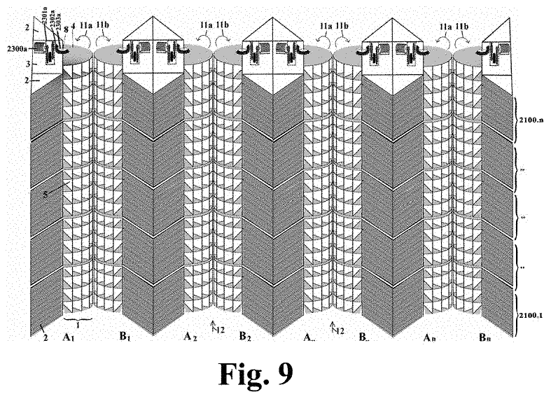

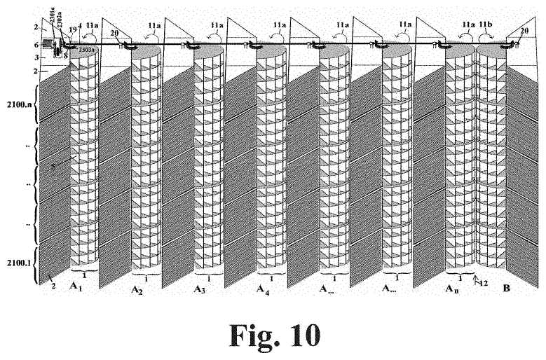

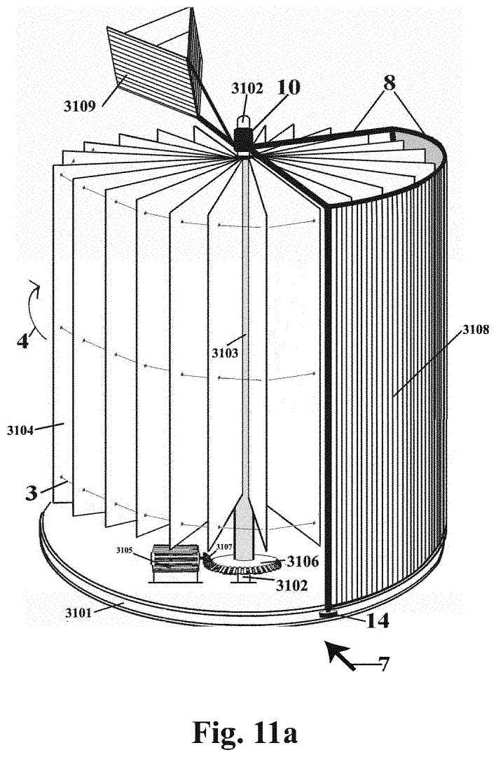

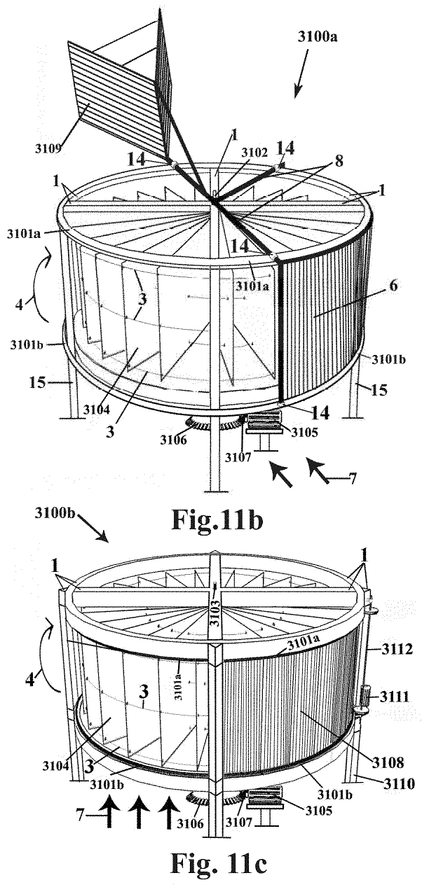

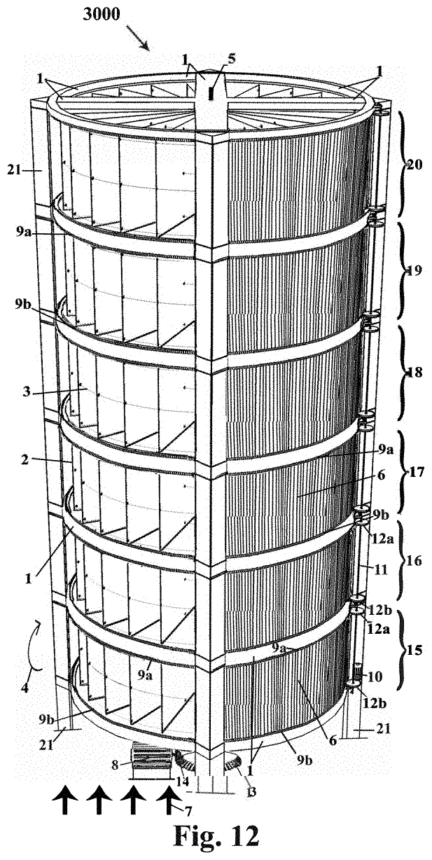

FIG. 8a illustrates front view of vertical axis device of the FIG. 1b as mirror image, tier installing multistory twin tower with individual generator on top of the towers otherwise tier arrangement of the FIG. 7a, according to embodiment as disclosed herein;

FIG. 8b illustrates front view of vertical axis device of the FIG. 1b as mirror image and tier installing multistory twin tower with horizontal shaft and common generator on top of the tower, generating electricity from wind, sea wave and water currents, according to embodiment as disclosed herein;

FIG. 9 illustrates front view of vertical axis device of the FIG. 1b as mirror imaged tier installing, multistory row of twin tower with individual generators on top of the towers, otherwise a row of FIG. 8a, generating electricity from wind, sea wave and water current, according to embodiment as disclosed herein;

FIG. 10 illustrates front view of vertical axis device of the FIG. 1b one sided tier installing, multistory towers row (except last tower) with horizontal shafted common generator on top of the tower, generating electricity from wind, sea waves and water current, in accordance with an exemplary embodiment,

FIG. 11a illustrates front view of vertical rotor axis installing device of the FIG. 1b, mounted on one pillar, round shaped and automatic curtain adjustment as opposite of wind, operated by wind directional, for generating electricity, according to another embodiment,

FIG. 11b illustrates front view of vertical rotor axis installed device of the FIG. 1b, round tower, mounted on pillars as automatic curtain adjustment, opposite of wind, and operated by wind directional, for power generation, according to another embodiment,

FIG. 11c illustrates front view of vertical rotor axis installed device of the FIG. 1b, rounded tower, mounted on the pillars, automatic curtain adjustment as opposite of wind by motorized operated, for wind power generation, according to another embodiment, and

FIG. 12 illustrates front view of vertical rotor axis installed device FIG. 1b, round shaped, tier arrangement multistory tower, mounted on the pillars as automatic of wind curtain adjustment system by motorized operated, according to another embodiment.

### DETAILED DESCRIPTION OF THE INVENTION

This present invention relates to renewable energy power generation from wind, water stream and sea waves, by arrangements, amendments systems and methods of the pioneer device the ‘wind power conversion device’ FIG. 1a.

In some configurations and referring to FIG. 1b, FIG. 1c, and FIG. 1d, right sided or left sided vertical installation FIG. 1b of device of the FIG. 1a, useful for making mirror images, round and vertical axis multistory devices. While arrangement of half barrel cutting shaped cover FIG. 1c is for rotor (1), thus the rotor (1) decreases the friction and increase the power generation. Thus rotor cover (6) made from any substance like cement concrete, iron, steel, plastic, PVC, bricks etc. Welded component parted rotor FIG. 1d is convenience instead of wire roped/steel angled supported rotor (1).

In an embodiment, the multistory power generation system (1000). The multistory power generation system (1000) includes a generator (300) connected to a vertical shaft (200) using a gear (302) with forward freewheel attachment and a gear (303) with a reverse freewheel attachment. One or more horizontal axis-based multistory wind mills (A1-An) comprises pillars (400), and a plurality of wind power conversion devices (100.1-100.n). Each of wind power conversion devices (100.1-100.n) comprises a horizontal axis-based cylindrical rotor (1) and is mounted on the pillar (400) and the vertical shaft (200) in a hierarchy using a geared freewheel (202). The geared freewheel (202) is connected to the vertical shaft (200) using a gear (203) on the vertical shaft (200). The incoming kinetic forces from wind or water rotates the horizontal axis-based cylindrical rotor (1) to rotate the vertical shaft (200) using the gear (203) and the geared freewheel (203). The rotation of the vertical shaft (200) in turn rotates the generator (300) through the gear (302 or 303) to generate power.

In an embodiment, each of the wind power conversion devices (100.1-100.n) includes a horizontal rotor shaft (5) connected to the pillar (400). The horizontal axis-based cylindrical rotor (1) is mounted on the horizontal rotor shaft (5) and includes a plurality of blades (2) each of which is connected using a rope or wire (4). The horizontal rotor cover (6) is connected to the pillar (400) using a bearing holder stand (11). The rotor cover (6) is in a semi-cylindrical shape or a slopped shape to partially enclose the horizontal axis-based cylindrical rotor (1) from the horizontal rotor shaft (5a).

In an embodiment, at least one of a size and a height of a wind power conversion devices (100.n) from the plurality of wind power conversion devices (100.1-100.n) mounted at a top story of the one or more horizontal axis-based multistory wind mills (A1-An) more than at least one of a size and/or a height of remaining wind power conversion devices from the plurality of wind power conversion devices (100.1-100.n) at lower story of the one or more horizontal axis-based multistory wind mill (A1-An). The at least one of the increased size and the increased size of the wind power conversion devices (100.n) at the top story is used to increase the power generation.

In an embodiment, a desired number of the horizontal axis-based multistory wind mills are lined up covering a particular length to generate more power, wherein each of the wind power conversion devices in the desired number of horizontal axis-based multistory wind mills is connected to the generator (300) using the vertical shaft (200).

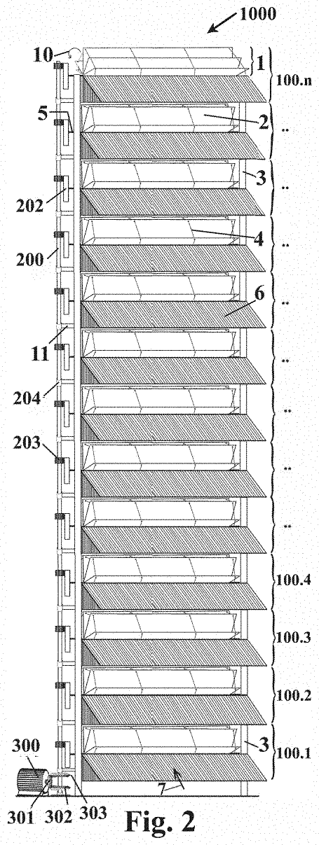

In some configurations and referring to FIG. 2, a tier arrangement of the pioneer device of the FIG. 1a as multistory wind mill tower FIG. 2. The height of the multistory windmill tower or number of the floors may be desirable or capacity of project, while width of tower/rotor (1) may be stand between 10 to 40 feet are suitable or capacity of project, and height of floor/rotor 10 to 40 feet are suitable or capacity of project.

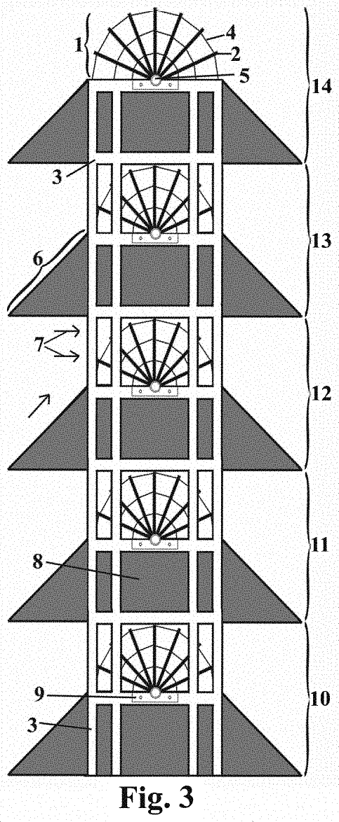

In some configurations and referring to FIG. 3, a cross sectional frame structure of tier arranged devices FIG. 1a. Thus multistory windmill towers are built in cement concrete column beam and tier arrangement with slopes shown in the FIG. 3.

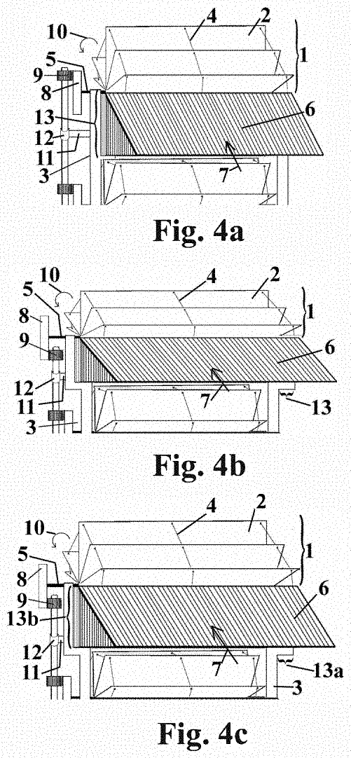

Referring to FIG. 4a, FIG. 4b, and FIG. 4c, over-sized arrangement of any opposite or four direction upper floor with rotor of the multistory wind mill tower to increase power generation. Both front and back sides of upper floor may be large than other lower floor as shown in the FIG. 4a, while left and right sides of the upper floor may be normal as shown in the FIG. 4b, both left and right sides of the upper floor with rotor (1) may be large than lower floor as shown in the FIG. 4b, while front and back sides are normal. When, all four sided wide upper floor with rotor than other floor of multistory windmill tower as shown in the FIG. 4b.

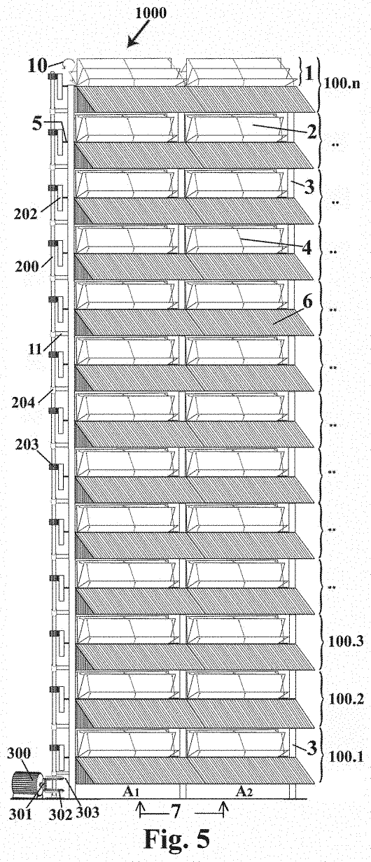

In some configurations and referring to FIG. 5, side by side line up installing arrangement and merger of two multistory windmill towers of the FIG. 2, which says twin multistory windmill tower shown in the FIG. 5. The rotor shafts (5) of the each floor are adjoined as like one shaft. The height of the multistory twins windmill tower or number of the floors may be desirable or depend on capacity of project, while width of rotor of each floor may be stand between 10 to 40 feet are suitable or depend on capacity of project, and height of floor/rotor 10 to 40 feet are suitable or depend on capacity of project.

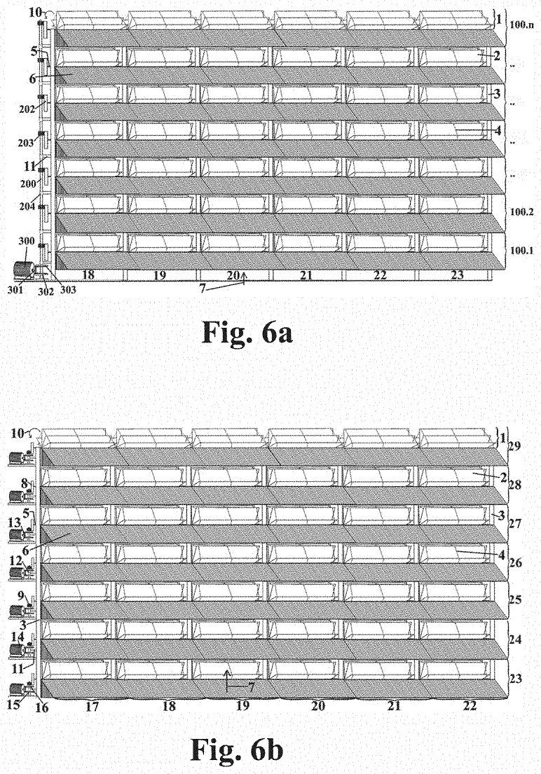

In some configurations and referring to FIG. 6a and FIG. 6b, side by side line up installing arrangement and merger of more than two multistory windmill towers as shown in the FIG. 2, its say multistory row windmill tower as shown in the FIG. 6a and FIG. 6b. The height of the multistory row windmill tower or number of the floors may be desirable or depend on capacity of project, length of the multistory row windmill tower may be desirable or depend on capacity of project, while width of rotor of each floor may be stand between 10 to 40 feet are suitable or depend on capacity of project, and height of each floor/rotor 10 to 40 feet are suitable or depend on capacity of project.

Where, multistory windmill tower of the FIG. 2, twin multistory windmill tower of the FIG. 5, multistory row windmill tower of the FIG. 6a are link up in order rotor shafts (5), of each floor, geared-flywheels (202), small gears (203), vertical main shaft (200), opposite fitted forward and backward freewheeled big gears (302, 303), and the generator 300 for power generation.

In an embodiment, multistory power generation system (1000) includes a plurality of horizontal axis-based multistory wind mills (A1-An) each of which comprises a plurality of wind power conversion devices (100.1-100.n). Each of the plurality of wind power conversion devices (100.1-100.n) includes a horizontal axis-based cylindrical rotor (1) and are mounted on the pillar (400) and the vertical shaft (200) in a hierarchy using a geared freewheel (202). The geared freewheel (202) is connected to the vertical shaft (200) using a gear (203) on the vertical shaft (200). A plurality of generators (300a-300n) is connected to the vertical shaft (200) using a gear (302) with forward freewheel attachment and a gear (303) with a reverse freewheel attachment at each story of the plurality of horizontal axis-based multistory wind mills (A1-An). The incoming kinetic forces from wind or water rotate the horizontal axis-based cylindrical rotor (1) to rotate the vertical shaft (200) using the gear (203) and the geared freewheel (203). The rotation of the vertical shaft (200) in turn rotates at least one of the generators (300a-300n) at each story through the gear (302 or 303) to generate power.

In an embodiment, the wind blow the opened rotor the (1) turn in to circular motion and wind energy reach to the generator (300) through above channels and generate grid quality electricity.

Further, the multistory windmill tower, twin multistory windmill tower, multistory row windmill tower having vertical one main shaft (17) with the generator (200) or individual generator per floor as shown in the FIG. 6b harness to and fro direction wind. Said multistory windmill towers are built in cement concrete column beam (3) and tier arrangement (10 to 14) as shown in the FIG. 3, thus multistory wind mill towers and rotors are built from any substance like, cement concrete, stainless steel, iron, PVC, plastics, carbon fiber, bricks, corrugate galvanized sheets etc.

In some configurations and referring to FIG. 7a, FIG. 7b, a mirror imaged FIG. 7a and FIG. 7 b installed arrangement of two vertical devices of the FIG. 1b, it says mirror imaged twin tower FIG. 7a and FIG. 7b.

As shown in the FIG. 7a and FIG. 8a, the multistory power generation system (2000) includes at least one first vertical axis-based multistory wind mill (A1) including a first generator (2300a) with a gear box (2301a) connected to at least one bevel gear (2302a and 2303a). A plurality of wind power conversion devices (2100.1a-2100.na) is arranged in a hierarchy and each of which includes a vertical axis-based cylindrical rotor (1a) connected to the generator (2300a) using the bevel gear (2302a and 2303a). The vertical axis-based cylindrical rotor (1a) rotates in a first direction. At least one second vertical axis-based multistory wind mill (B1) including a first generator (2300b) with a gear box (2301b) connected to at least one bevel gear (2302b and 2303b). A plurality of wind power conversion devices (2100.1b-2100.nb) is arranged in a hierarchy in opposite to the plurality of wind power conversion devices (2100.1a-2100.na) and each of wind power conversion devices (2100.1b-2100.nb) comprises a vertical axis-based cylindrical rotor (1b) connected to the generator (300b) using the bevel gear (2302b and 2303b). The vertical axis-based cylindrical rotor (1b) rotates in a second direction. The incoming kinetic forces from wind or water rotate the vertical axis-based cylindrical rotor (1a and 1b) to rotate the generator (2300a) through the bevel gear (2302a and 2303a) and the generator (2300b) through the bevel gear (2302b and 2303b) to generate power.

In an embodiment, each of the first wind power conversion devices (2100.1a-2100.na) includes a vertical rotor shaft (5a) on which the vertical axis-based cylindrical rotor (1a) is mounted. The vertical axis-based cylindrical rotor (1a) includes a plurality of blades (2a) each of which is connected using a rope or wire (4a). A vertical rotor cover (6a) is arranged on each other in the hierarchy. The rotor cover (6a) is in a semi-cylindrical shape or a slopped shape to partially enclose the vertical axis-based cylindrical rotor (1a) from the vertical rotor shaft (5a).

In an embodiment, each of the second wind power conversion devices (2100.1b-2100.nb) includes a vertical rotor shaft (5b) on which the vertical axis-based cylindrical rotor (1b) is mounted. The vertical axis-based cylindrical rotor (1b) includes a plurality of blades (2b) each of which is connected using a rope or wire (4b). A vertical rotor cover (6b) is arranged on each other in the hierarchy. The rotor cover (6b) is in a semi-cylindrical shape or a slopped shape to partially enclose the vertical axis-based cylindrical rotor (1b) from the vertical rotor shaft (5b).

In an embodiment, a desired number of the at least one first vertical axis-based multistory wind mill (2100.1a-2100.na) and the at least one second vertical axis-based multistory wind mill (2100.1b-2100.nb) are lined up in opposite directions covering a particular length to generate more power. Each of the wind power conversion devices in the desired number of the at least one first vertical axis-based multistory wind mill (2100.1a-2100.na) is connected to the generator (2300a) and the at least one second vertical axis-based multistory wind mill (2100.1b-2100.nb) is connected to the generator (2300b).

As shown in the FIG. 7b and FIG. 8b, the multistory power generation system (2000) includes a generator (2300) with a gear box (2301) connected to at least one bevel gear (2302 and 2303). At least one first vertical axis-based multistory wind mill (A1) includes a plurality of wind power conversion devices (2100.1a-2100.na) arranged in a hierarchy and each of which comprises a vertical axis-based cylindrical rotor (1a) connected to the generator (2300) using the bevel gear (2302 and 2303). The vertical axis-based cylindrical rotor (1a) rotates in a first direction. At least one second vertical axis-based multistory wind mill (B1) includes a plurality of wind power conversion devices (2100.1b-1200.nb) arranged in a hierarchy in opposite to the plurality of wind power conversion devices (2100.1a-2100.na) of the at least one first vertical axis-based multi multistory wind mill (A1) and each of the wind power conversion devices (2100.1b-2100.nb) includes a vertical axis-based cylindrical rotor (1b) connected to the generator (2300) using the common shaft (2200), wherein the vertical axis-based cylindrical rotor (1b) rotates in a second direction. The incoming kinetic forces from wind or water rotates the vertical axis-based cylindrical rotor (1a and 1b) to rotate the generator (300) through the bevel gear (2302 and 2303) to generate power.

In an embodiment, each of the first wind power conversion devices (2100.1a-2100.na) includes a vertical rotor shaft (5a) on which the vertical axis-based cylindrical rotor (1a) is mounted. The axis-based cylindrical rotor (1a) includes a plurality of blades (2a) each of which is connected using a rope or wire (4a). A rotor cover (6a) is arranged on each other in the hierarchy. The rotor cover (6a) is in a semi-cylindrical shape or a slopped shape to partially enclose the vertical axis-based cylindrical rotor (1a).

In an embodiment, each of the second wind power conversion devices (2100.1b-2100.nb) includes a vertical rotor shaft (5b) on which the vertical axis-based cylindrical rotor (1b) is mounted. The vertical axis-based cylindrical rotor (1b) includes a plurality of blades (2b) each of which is connected using a rope or wire (4b). A vertical rotor cover (6b) is arranged on each other in the hierarchy. The rotor cover (6b) is in a semi-cylindrical shape or a slopped shape to partially enclose the vertical axis-based cylindrical rotor (1b).

In an embodiment, a desired number of the at least one first vertical axis-based multistory wind mill (A1-An) and the at least one second vertical axis-based multistory wind mill (B1-Bn) are lined up in opposite direction covering a particular length to generate more power. Each of the wind power conversion devices in the desired number of vertical axis-based multistory wind mills is connected to the generator (2300).

In some configurations and referring to FIG. 8a and FIG. 8b, the tier installing arrangement of the FIG. 8a and FIG. 8b (14 to 18) are two vertical mirror imaged multistory twin tower arrangement of the FIG. 8a, FIG. 8b.

In some configurations and referring to FIG. 9, the a side by side line up installing arrangement of mirror imaged multistory twin tower of the FIG. 8a or FIG. 8b, it says mirror imaged multistory row of twin tower.

In some configurations and referring to FIG. 10, the multistory power generation system (2000) is a one sided line up tier installed arrangement of the vertical devices, it says one sided row of multistory tower FIG. 10, while last multistory tower of the row stand as mirror imaged FIG. 10.

The height of the mirror imaged twin tower device of the FIG. 7a, and FIG. 7b, the mirror imaged multistory twin tower device of the FIG. 8a, FIG. 8b, one sided row of multistory tower FIG. 10 or number of the tier (floors) may be desirable or depend on capacity of project, while width of rotor of each floor may be stand between 5 to 40 feet are suitable or depend on capacity of project, and height of each floor/rotor 5 to 40 feet are suitable or depend on capacity of project.

As shown in the FIG. 7-FIG. 10, the multistory power generation system (2000) includes a generator (2300) with a gear box (2301) connected to at least one bevel gear (2302 and 2303). A plurality of first vertical axis-based multistory wind mill (A1-An) includes a plurality of wind power conversion devices (2100.1a-2100.na) arranged in a hierarchy and each of which comprises a vertical axis-based cylindrical rotor (1) connected to the generator (2300) using the bevel gear (2302 and 2303). The vertical axis-based cylindrical rotor (1) rotates in a first direction. The incoming kinetic forces from wind or water rotates the vertical axis-based cylindrical rotor (1) to rotate the generator (2300) through the bevel gear (2302 and 2303) to generate power.

In an embodiment, each of the first wind power conversion devices (2100.1a-2100.nb) includes a vertical rotor shaft (5) on which the vertical axis-based cylindrical rotor (1) is mounted. The vertical axis-based cylindrical rotor (1) includes a plurality of blades (2) each of which is connected using a rope or wire (4). A rotor cover (6) is arranged on each other in the hierarchy. The cover (6) is in a semi-cylindrical shape or a slopped shape to partially enclose the vertical axis-based cylindrical rotor (1) from the vertical rotor shaft (5).

In an embodiment, a desired number of first vertical axis-based multistory wind mills are lined up covering a particular length to generate more power, wherein each of the wind power conversion devices in the desired number of first vertical axis-based multistory wind mills is connected to the generator (2300) using a vertical rotor shaft (5).

In an embodiment, at least one second vertical axis-based multistory wind mill (B1) includes a plurality of wind power conversion devices (2100.1b-2100.nb) arranged in a hierarchy and in opposite to wind power conversion devices (2100.1a-2100.na) and each of the wind power conversion devices (2100.1b-2100.nb) includes a vertical axis-based cylindrical rotor (1) connected to the generator (2300) using the bevel gear (2302a and 2303a). The vertical axis-based cylindrical rotor (1) rotates in a second direction. The incoming kinetic force from wind or water rotates the vertical axis-based cylindrical rotor (1) to rotate the generator (2300) through the bevel gear (2302a and 2303a) to generate power.

The mirror imaged twin tower of the FIG. 7a, FIG. 7b, mirror imaged multistory twin tower FIG. 8a, FIG. 8b, and one sided row of multistory tower are arranged in order link up the rotor shafts FIG. 7a, FIG. 8a, FIG. 9 of each floor, big gear (9), the gear box with fly wheels (7), and the generator (6), settle on the individual towers, while towers having one horizontal main shaft (14), is linkup in order gear box with fly wheels (7), and the generator (6), the circular motion of the rotors of twin tower stand are arranged opposite direction as shown in the FIG. 7a-FIG. 9.

Thus, wind or sea waves or water stream push the opened rotor (1), and turn in to circular motion and renewable energy reach to the generator (6), through the channels and generate grid quality electricity.

Further, the mirror imaged twin tower of the FIG. 7a, and FIG. 7b, mirror imaged multistory twin tower of the FIG. 8a and FIG. 8b, and mirror imaged multistory row of twin towers of the FIG. 9 and one sided row of multistory tower of the FIG. 10 can harness to and fro direction wind or sea waves or water stream (tides) and said rotors and towers can be built from any substance like, cement concrete, stainless steel, iron, PVC, plastics, carbon fiber, bricks, corrugate galvanized sheets etc.

In some configurations and referring to FIG. 11a, an arrangement of the vertical installing devices of the FIG. 1b, having round shaped, single pole surrounded hollow shaft (5) welded with big gear (13) and settled on the pole by two bearing, the rotor (2) which is welded surrounded the hollow shaft (5). The bearing (10) is settled on the pole (1), the wind directional device (9) and the rotor cover (6) are welded opposite direction by frame structure (8), the two wheels/bearings (14) settle on both lower borders of the rotor cover (6), the two wheels/bearings (14) are settle on the track (15), the generator (3105) is link up big gear (13) by the small gear (12).

In some configurations and referring to FIG. 11b, an arrangement of the vertical installing devices of the FIG. 1b, mounted on two to four columns of the FIG. 11b(15) with beam of the FIG. 11b(1), round shaped, the rotor (1) is welded surrounded the shaft (3102), the wind directional (9) and the cover (6) are welded opposite direction by frame structure (8), the two wheels/bearings (14) is settle on both lower border of the curtain and three wheels/bearings are settle on the frame structure (8), the two tracks are built. The generator (11) is settle under the tower and link up with the shaft (5) and big gear (12) via the small gear (13).

When wind current (7) passes over the device of the FIG. 11a, FIG. 11b at a same time face of the half rotor is covered automatically by curtain by wind directional, while half rotor keep opened, this process stay on constant opposite of wind, thus wind blow the half opened rotor and the rotor move turn in to circular motion of the FIG. 11a and FIG. 11b, thus wind energy passes in order big gear, small gear, generator for generate electricity.

In some configurations and referring to FIG. 11c, an arrangement of the vertical installing devices of the FIG. 1b, mounted on two to four columns of the FIG. 11c with beam of the FIG. 11c(1), round shaped, the rotor (2) is welded surrounded the shaft (5), the one scrolling track (9b) settled under the curtain (6) while second scrolling track (9a) is settle on the curtain, the curtain (6) settled between two scrolling track, the half curtain stay on opposite of wind by automatic motorized part (10) adjustment, the generator (8) is settle under the tower and link up the shaft (5), big gear (13) via small gear (14) for power generation.

As shown in the FIG. 11a and FIG. 11b, vertical axis based rotor device (3100a) includes a vertical rotor shaft (3103) fixed on a movable channel (3101) using a fixed shaft (3102). A rotor includes a plurality of blades (3104) mounted on the fixed shaft (3102). A generator (3105) is connected to the fixed shaft (3102) using at least one gear (3106 and 3107) of the vertical rotor shaft (3103). A rotor cover (3108) is partially enclosed the plurality of blades (3104) and is connected to the fixed shaft (3103). A wind director (3109) is connected to the fixed shaft (3103), wherein incoming kinetic forces from wind rotates the wind director (3109) which in turn rotates the rotator cover (3108) in a direction opposite to the wind to generate power.

In an embodiment, the incoming kinetic forces from the wind or water rotates the rotor (1) to rotate which in turn rotates the generator (3105) through the gear (3106 and 3107) to generate the power.

In an embodiment, the movable channel (3101) is mounted on pillars (3110).

As shown in the FIG. 11c, vertical axis based rotor device (3100b) includes an upper geared channel (3101a) and a lower geared channel (3101b) mounted on pillars (3110). A vertical rotor shaft (3102) is fixed on the movable channel (3101) using a fixed shaft (3103). A rotor includes a plurality of blades (3104) mounted on the fixed shaft (3103). A generator (3105) is connected to the fixed shaft (3103) using at least one gear (3106 and 3107) of the vertical rotor shaft (3102). A rotor cover (3108) partially encloses the plurality of blades (3104) and is connected to the fixed shaft (3103). A motor (3111) is connected to the upper geared channel (3101a) and the lower geared channel (3101b) using a motor shaft (3112). The motor (3111) is configured to rotate the rotator cover (3108) in a direction opposite to the wind or water to generate power.

In an embodiment, incoming kinetic forces from the wind or water rotates the rotor (1) to rotate which in turn rotates the generator (3105) through the gear (3106 and 3107) to generate the power.

As shown in the FIG. 12, multistory power generation system (3000) includes a plurality of vertical axis based rotor devices (3100b1-3100bn) each of which mounted on the vertical shaft (3200) in a hierarchy. Each of the vertical axis based rotor devices (3100b1-3100bn) includes an upper geared channel (3101a) and a lower geared channel (3010b) mounted on pillars (3110). A vertical rotor shaft (3102) is fixed on the movable channel (3101) using a fixed shaft (3103). A rotor includes a plurality of blades (3104) mounted on the fixed shaft (3103). A motor (3111) is connected to the upper geared channel (3101a) and the lower geared channel (3010b) using a motor shaft (3112). The motor (3111) is configured to rotate the rotator cover (3108) in a direction opposite to the wind or water to generate power. A generator (3105) is connected to the fixed shaft (3103) using at least one gear (3106 and 3107) of the vertical rotor shaft (3102). Incoming kinetic forces from the wind or water rotates the rotor (1) to rotate which in turn rotates the generator (3105) through the gear (3106 and 3107) to generate the power.

In some configurations and referring to FIG. 12, a tier arrangement of the vertical installing automatic tower, it says automatic motorized multistory round windmill tower, mounted on two to four columns (21) with beam (1), round shaped.

The rotor (2) is welded surrounded the shaft (5). The first scrolling track (9b) is settled under the rotor cover (3108) while second scrolling track whose upper side of the rotor cover is settled between two scrolling track of each floor, the half curtain stay on opposite of wind by automatic motorized adjustment, the generator (2300) is settle under the tower and link up the vertical shaft (3200), big gear (3106) via the small gear (3107).

As shown in the FIG. 11c and FIG. 12, When the wind passes over the device at that time face of the half rotor is covered by motorized curtain, while half rotor stay on opened, this process stay on constant opposite of wind, thus wind blow the half opened rotor and the rotor move turn in to circular motion, now wind energy pass through link up in order big gear, small gear to generator, and generate electricity.

The rotors height of the automatic single pole windmill, automatic poles mounted windmill, automatic motorized round windmill tower may be stand 10 to 40 feet are suitable or depend on capacity of project. width of rotor may be stand between 10 to 40 feet are suitable or depend on capacity of project, while height of the automatic motorized multistory round windmill tower of the or number of the floors of the FIG. 12 may be desirable or depend on capacity of project, while width of rotor of each floor may be stand between 10 to 40 feet are suitable or capacity of project, and height of each floor/rotor 10 to 40 feet are suitable or depend on capacity of project. Said rotors and towers are built from any substance like, cement concrete, stainless steel, iron, PVC, plastics, carbon fiber, bricks, corrugate galvanized sheets etc.

1-16. (canceled)

17. A multistory power generation system (1000) comprising:
a vertical shaft (200)
a generator (300) connected to the vertical shaft (200) using a gear (302) with forward freewheel attachment and a gear (303) with a reverse freewheel attachment; and
one or more horizontal axis-based multistory wind mills (A1-An) comprises:
pillars (400), and
a plurality of wind power conversion devices (100.1-100.n) each of which comprises a horizontal axis-based cylindrical rotor (1) and are mounted on the pillar (400) and the vertical shaft (200) in a hierarchy using a geared freewheel (202),
wherein the geared freewheel (202) is connected to the vertical shaft (200) using a gear (203) on the vertical shaft (200),
wherein incoming kinetic forces from wind or water rotates the horizontal axis-based cylindrical rotor (1) to rotate the vertical shaft (200) using the gear (203) and the geared freewheel (203), and
wherein the rotation of the vertical shaft (200) in turn rotates the generator (300) through the gear (302 or 303) to generate power.

18. The multistory power generation system (1000) of claim 17, wherein each of the wind power conversion devices (100.1-100.n) comprises:
a horizontal rotor shaft (5) connected to the pillar (400), wherein the horizontal axis-based horizontal axis-based cylindrical rotor (1) is mounted on the horizontal rotor shaft (5) and comprises a plurality of blades (2) each of which is connected using a rope or wire (4);
a horizontal rotor cover (6) connected to the pillar (400) using a bearing holder stand (11), wherein the rotor cover (6) is in a semi-cylindrical shape or a slopped shape to partially enclose the horizontal axis-based cylindrical rotor (1) from the horizontal rotor shaft (5a).

19. The multistory power generation system (1000) of claim 17, wherein at least one of a size and a height of a wind power conversion devices (100.n) from the plurality of wind power conversion devices (100.1-100.n) mounted at a top story of the one or more horizontal axis-based multistory wind mills (A1-An) more than at least one of a size and/or a height of remaining wind power conversion devices from the plurality of wind power conversion devices (100.1-100.n) at lower story of the one or more horizontal axis-based multistory wind mill (A1-An), wherein at least one of the increased size and the increased size of the wind power conversion devices (100.n) at the top story is used to increase the power generation.

20. The multistory power generation system (1000) of claim 17, wherein a desired number of the horizontal axis-based multistory wind mills are lined up covering a particular length to generate more power, wherein each of the wind power conversion devices in the desired number of horizontal axis-based multistory wind mills is connected to the generator (300) using the vertical shaft (200).

21. A multistory power generation system (2000) comprising:
a common shaft (2200);
a generator (2300) comprising a gear box (2301) connected to at least one bevel gear (2302 and 2303);
at least one first vertical axis-based multistory wind mill (A1) comprising a plurality of wind power conversion devices (2100.1a-2100.na) arranged in a hierarchy and each of which comprises a vertical axis-based cylindrical rotor (1a) connected to the generator (2300) using the bevel gear (2302 and 2303), wherein the vertical axis-based cylindrical rotor (1a) rotates in a first direction;
at least one second vertical axis-based multistory wind mill (B1) comprising a plurality of wind power conversion devices (2100.1b-1200.nb) arranged in a hierarchy in opposite to the plurality of wind power conversion devices (2100.1a-2100.na) of the at least one first vertical axis-based multi multistory wind mill (A1) and each of the wind power conversion devices (2100.1b-2100.nb) comprises a vertical axis-based cylindrical rotor (1b) connected to the generator (2300) using the common shaft (2200), wherein the vertical axis-based cylindrical rotor (1b) rotates in a second direction;
wherein incoming kinetic forces from wind or water rotates the vertical axis-based cylindrical rotor (1a and 1b) to rotate the generator (300) through the bevel gear (2302 and 2303) to generate power.

22. The multistory power generation system (2000) of claim 21, wherein each of the first wind power conversion devices (2100.1a-2100.na) comprises:
a vertical rotor shaft (5a) on which the vertical axis-based cylindrical rotor (1a) is mounted, wherein the vertical axis-based cylindrical rotor (1a) comprises a plurality of blades (2a) each of which is connected using a rope or wire (4a);
a rotor cover (6a) arranged on each other in the hierarchy, wherein the rotor cover (6a) is in a semi-cylindrical shape or a slopped shape to partially enclose the vertical axis-based cylindrical rotor (1a).

23. The multistory power generation system (2000) of claim 21, wherein each of the second wind power conversion devices (2100.1b-2100.nb) comprises:
a vertical rotor shaft (5b) on which the vertical axis-based cylindrical rotor (1b) is mounted, wherein the vertical axis-based cylindrical rotor (1b) comprises a plurality of blades (2b) each of which is connected using a rope or wire (4b);
a vertical rotor cover (6b) arranged on each other in the hierarchy, wherein the rotor cover (6b) is in a semi-cylindrical shape or a slopped shape to partially enclose the vertical axis-based cylindrical rotor (1b).

24. The multistory power generation system (2000) of claim 21, wherein a desired number of the at least one first vertical axis-based multistory wind mill (A1-An) and the at least one second vertical axis-based multistory wind mill (B1-Bn) are lined up in opposite direction covering a particular length to generate more power, wherein each of the wind power conversion devices in the desired number of vertical axis-based multistory wind mills is connected to the generator (2300).

25. A multistory power generation system (2000) comprising:
at least one first vertical axis-based multistory wind mill (A1) comprising a first generator (2300a) comprising a gear box (2301a) connected to at least one bevel gear (2302a and 2303a), a plurality of wind power conversion devices (2100.1a-2100.na) arranged in a hierarchy and each of which comprises a vertical axis-based cylindrical rotor (1a) connected to the generator (2300a) using the bevel gear (2302a and 2303a), wherein the vertical axis-based cylindrical rotor (1a) rotates in a first direction;
at least one second vertical axis-based multistory wind mill (B1) comprising a first generator (2300b) comprising a gear box (2301b) connected to at least one bevel gear (2302b and 2303b), a plurality of wind power conversion devices (2100.1b-2100.nb) arranged in a hierarchy in opposite to the plurality of wind power conversion devices (2100.1a-2100.na) and each of wind power conversion devices (2100.1b-2100.nb) comprises a vertical axis-based cylindrical rotor (1b) connected to the generator (300b) using the bevel gear (2302b and 2303b), wherein the vertical axis-based cylindrical rotor (1b) rotates in a second direction;
wherein incoming kinetic forces from wind or water rotates the vertical axis-based cylindrical rotor (1a and 1b) to rotate the generator (2300a) through the bevel gear (2302a and 2303a) and the generator (2300b) through the bevel gear (2302b and 2303b) to generate power.

26. The multistory power generation system (2000) of claim 25, wherein each of the first wind power conversion devices (2100.1a-2100.na) comprises:
a vertical rotor shaft (5a) on which the vertical axis-based cylindrical rotor (1a) is mounted, wherein the vertical axis-based cylindrical rotor (1a) comprises a plurality of blades (2a) each of which is connected using a rope or wire (4a);
a vertical rotor cover (6a) arranged on each other in the hierarchy, wherein the rotor cover (6a) is in a semi-cylindrical shape or a slopped shape to partially enclose the vertical axis-based cylindrical rotor (1a) from the vertical rotor shaft (5a).

27. The multistory power generation system (2000) of claim 25, wherein each of the second wind power conversion devices (2100.1b-2100.nb) comprises:
a vertical rotor shaft (5b) on which the vertical axis-based cylindrical rotor (1b) is mounted, wherein the vertical axis-based cylindrical rotor (1b) comprises a plurality of blades (2b) each of which is connected using a rope or wire (4b);
a vertical rotor cover (6b) arranged on each other in the hierarchy, wherein the rotor cover (6b) is in a semi-cylindrical shape or a slopped shape to partially enclose the vertical axis-based cylindrical rotor (1b) from the vertical rotor shaft (5b).

28. The multistory power generation system (2000) of claim 25, wherein a desired number of the at least one first vertical axis-based multistory wind mill (2100.1a-2100.na) and the at least one second vertical axis-based multistory wind mill (2100.1b-2100.nb) are lined up in opposite directions covering a particular length to generate more power, wherein each of the wind power conversion devices in the desired number of the at least one first vertical axis-based multistory wind mill (2100.1a-2100.na) is connected to the generator (2300a) and the at least one second vertical axis-based multistory wind mill (2100.1b-2100.nb) is connected to the generator (2300b).

29. A multistory power generation system (2000) comprising:
a generator (2300) comprising a gear box (2301) connected to at least one bevel gear (2302 and 2303); and
a plurality of first vertical axis-based multistory wind mill (A1-An) each of which comprises:
a plurality of wind power conversion devices (2100.1a-2100.na) arranged in a hierarchy and each of which comprises a vertical axis-based cylindrical rotor (1) connected to the generator (2300) using the bevel gear (2302 and 2303), wherein the vertical axis-based cylindrical rotor (1) rotates in a first direction,
wherein incoming kinetic forces from wind or water rotates the vertical axis-based cylindrical rotor (1) to rotate the generator (2300) through the bevel gear (2302 and 2303) to generate power.

30. The multistory power generation system (2000) of claim 29, wherein each of the first wind power conversion devices (2100.1a-2100.nb) comprises:
a vertical rotor shaft (5) on which the vertical axis-based cylindrical rotor (1) is mounted, wherein the vertical axis-based cylindrical rotor (1) comprises a plurality of blades (2) each of which is connected using a rope or wire (4); and
a rotor cover (6) arranged on each other in the hierarchy, wherein the rotor cover (6) is in a semi-cylindrical shape or a slopped shape to partially enclose the vertical axis-based cylindrical rotor (1) from the vertical rotor shaft (5).

31. The multistory power generation system (2000) of claim 29, wherein a desired number of first vertical axis-based multistory wind mills are lined up covering a particular length to generate more power, wherein each of the wind power conversion devices in the desired number of first vertical axis-based multistory wind mills is connected to the generator (2300) using a vertical rotor shaft (5).

32. The multistory power generation system (2000) of claim 29, comprising at least one second vertical axis-based multistory wind mill (B1) comprises:
a plurality of wind power conversion devices (2100.1b-2100.nb) arranged in a hierarchy and in opposite to wind power conversion devices (2100.1a-2100.na) and each of the wind power conversion devices (2100.1b-2100.nb) comprises a vertical axis-based cylindrical rotor (1) connected to the generator (2300) using the bevel gear (2302a and 2303a), wherein the vertical axis-based cylindrical rotor (1) rotates in a second direction,
wherein incoming kinetic forces from wind or water rotates the vertical axis-based cylindrical rotor (1) to rotate the generator (2300) through the bevel gear (2302a and 2303a) to generate power.

33. A multistory power generation system (1000), comprising:
a vertical shaft (200);
a plurality of horizontal axis-based multistory wind mills (A1-An) each of which comprises:
pillars (400), and
a plurality of wind power conversion devices (100.1-100.n) each of which comprises a horizontal axis-based cylindrical rotor (1) and are mounted on the pillar (400) and the vertical shaft (200) in a hierarchy using a geared freewheel (202), wherein the geared freewheel (202) is connected to the vertical shaft (200) using a gear (203) on the vertical shaft (200); and
a plurality of generators (300a-300n) each of which connected to the vertical shaft (200) using a gear (302) with forward freewheel attachment and a gear (303) with a reverse freewheel attachment at each story of the plurality of horizontal axis-based multistory wind mills (A1-An),
wherein incoming kinetic forces from wind or water rotates the horizontal axis-based cylindrical rotor (1) to rotate the vertical shaft (200) using the gear (203) and the geared freewheel (203), and
wherein the rotation of the vertical shaft (200) in turn rotates at least one of the generators (300a-300n) at each story through the gear (302 or 303) to generate power.

34. A vertical axis based rotor device (3100a) comprising:
a movable channel (3101);
a vertical rotor shaft (3102) fixed on the movable channel (3101) using a fixed shaft (3103);
a rotor comprising a plurality of blades (3104) mounted on the fixed shaft (3103);
a generator (3105) connected to the fixed shaft (3103) using at least one gear (3106 and 3107) of the vertical rotor shaft (3102);
a rotor cover (3108) to partially enclose the plurality of blades (3104) and is connected to the fixed shaft (3103); and
a wind director (3109) connected to the fixed shaft (3103), wherein incoming kinetic forces from wind rotates the wind director (3109) which in turn rotates the rotator cover (3108) in a direction opposite to the wind to generate power.

35. The vertical axis based rotor device (3100a) of claim 34, wherein the incoming kinetic forces from the wind rotates the rotor (1) to rotate which in turn rotates the generator (3105) through the gear (3106 and 3107) to generate the power.

36. The vertical axis based rotor device (3100a) of claim 34, wherein the movable channel (3101) mounted on pillars (3110).

37. A vertical axis based rotor device (3100b) comprising:
an upper geared channel (3101a) and a lower geared channel (3010b) mounted on pillars (3110);
a vertical rotor shaft (3102) fixed on the movable channel (3101) using a fixed shaft (3103);
a rotor comprising a plurality of blades (3104) mounted on the fixed shaft (3103);
a generator (3105) connected to the fixed shaft (3103) using at least one gear (3106 and 3107) of the vertical rotor shaft (3102);
a rotor cover (3108) to partially enclose the plurality of blades (3104) and is connected to the fixed shaft (3103); and
a motor (3111) connected to the upper geared channel (3101a) and the lower geared channel (3010b) using a motor shaft (3112), wherein motor is configured to rotate the rotator cover (3108) in a direction opposite to the wind or water to generate power.

38. The vertical axis based rotor device (3100b) of claim 37, wherein incoming kinetic forces from the wind or water rotates the rotor (1) to rotate which in turn rotates the generator (3105) through the gear (3106 and 3107) to generate the power.

39. A multistory power generation system (3000) comprising:
a plurality of vertical axis based rotor devices (3100b1-3100bn) each of which mounted on the vertical shaft (3200) in a hierarchy, wherein each of the vertical axis based rotor devices (3100b1-3100bn) comprising:
a upper geared channel (3101a) and a lower geared channel (3010b) mounted on pillars (3110),
a vertical rotor shaft (3102) fixed on the movable channel (3101) using a fixed shaft (3103),
a rotor comprising a plurality of blades (3104) mounted on the fixed shaft (3103),
a motor (3111) connected to the upper geared channel (3101a) and the lower geared channel (3010b) using a motor shaft (3112), wherein motor is configured to rotate the rotator cover (3108) in a direction opposite to the wind or water to generate power;
a generator (3105) connected to the fixed shaft (3103) using at least one gear (3106 and 3107) of the vertical rotor shaft (3102);
wherein incoming kinetic forces from the wind or water rotates the rotor (1) to rotate which in turn rotates the generator (3105) through the gear (3106 and 3107) to generate the power.
